(19) United States
(12) Patent Application Publication
(10) Pub. No.: US 2015/0237247 A1
(43) Pub. Date: Aug. 20, 2015

(54) INFORMATION PROCESSING APPARATUS, INFORMATION PROCESSING METHOD, INFORMATION PROCESSING SYSTEM, AND IMAGING APPARATUS

(71) Applicant: Sony Corporation, Tokyo (JP)

(72) Inventor: Akihiro Hara, Kanagawa (JP)

(21) Appl. No.: 14/614,963

(22) Filed: Feb. 5, 2015

(30) Foreign Application Priority Data
Feb. 18, 2014 (JP) 2014-028749

(51) Int. Cl. H04N 5/235

(52) U.S. Cl. CPC H04N 5/2353

(57) ABSTRACT

An information processing apparatus according to the present disclosure includes an image processing section configured to generate a first image based on a first exposure period and a second image based on a second exposure period including the first exposure period.

### CROSS REFERENCE TO RELATED APPLICATIONS

This application claims the benefit of Japanese Priority Patent Application JP 2014-028749 filed Feb. 18, 2014, the entire contents of which are incorporated herein by reference.

### BACKGROUND

The present disclosure relates to an imaging apparatus having an imaging function and an information processing apparatus, an information processing method, and an information processing system which are able to be applied to the imaging apparatus.

In an imaging apparatus including an imaging sensor such as a complementary metal-oxide semiconductor (CMOS), a global shutter type and a rolling shutter type have been used as an electronic shutter type. The global shutter type imaging apparatus performs an electronic shutter operation simultaneously in the entirety of pixels. For this reason, exposure timings at all the pixels are the same in the global shutter type imaging apparatus. The rolling shutter type imaging apparatus performs an electronic shutter operation for, for example, one horizontal line. For this reason, exposure timings are shifted for, for example, one horizontal line in the rolling shutter imaging apparatus. The rolling shutter type is also referred to as a focal plane shutter type.

### SUMMARY

As disclosed in Japanese Unexamined Patent Application Publication No. 2013-081060, for example, a method of composing a plurality of captured images having an exposure period (shutter speed) different from each other in an imaging apparatus in order to expand a dynamic range has been used. In this method, since the plurality of captured images captured respectively during periods which are not superimposed on each other in time are composed, image quality after composition is degraded in, for example, a case where a subject moves. The method disclosed in Japanese Unexamined Patent Application Publication No. 2013-081060 may only be applied to a video mode in which a reading speed is high because the number of reading lines for a signal from an imaging sensor is reduced. If a still image is captured by using the method disclosed in Japanese Unexamined Patent Application Publication No. 2013-081060, focal plane distortion occurs and image quality is degraded to a large extent.

Japanese Unexamined Patent Application Publication No. 2011-244309 has proposed a method in which a plurality of captured images are generated by performing a shutter operation on two lines of a first line and a second line different from the first line at a shutter speed different from each other in an imaging sensor. In this method, start time in an accumulation period of a signal is arranged in the imaging sensor and thus time lag between the plurality of captured images at a start of imaging does not occur. However, since images of two lines different from each other in spatial coordinates are composed, unnatural figures may be generated. The number of vertical lines of a captured image before composition is reduced by half.

It is desirable to provide an information processing apparatus, an information processing method, an information processing system, and an imaging apparatus rapidly generating a plurality of captured images having a shutter speed different from each other.

An information processing apparatus according to an embodiment of the present disclosure includes an image processing section configured to generate a first image based on a first exposure period and a second image based on a second exposure period including the first exposure period.

An information processing method according to an embodiment of the present disclosure causes an image processing section to generate a first image based on a first exposure period and a second image based on a second exposure period including the first exposure period.

An information processing system according to an embodiment of the present disclosure includes an image processing section configured to generate a first image based on a first exposure period and a second image based on a second exposure period including the first exposure period.

The information processing system according to the embodiment of the present disclosure may include an imaging apparatus configured to output multiple items of captured image data having an exposure start timing different from each other. The image processing section may generate the first image and the second image based on the multiple items of captured image data output from the imaging apparatus.

An imaging apparatus according to an embodiment of the present disclosure includes an image processing section configured to generate a first image based on a first exposure period and a second image based on a second exposure period including the first exposure period.

The imaging apparatus according to the embodiment of the present disclosure may include a sensor section configured to output multiple items of captured image data having an exposure start timing different from each other. The image processing section may generate the first image and the second image based on the multiple items of captured image data output from the sensor section.

The information processing apparatus, the information processing method, the information processing system, or the imaging apparatus according to the embodiment of the present disclosure generates the first image based on the first exposure period and the second image based on the second exposure period including the first exposure period.

According to the information processing apparatus, the information processing method, the information processing system, or the imaging apparatus of the embodiment in the present disclosure, since a first image is generated based on a first exposure period and a second image is generated based on a second exposure period including the first exposure period, it is possible to rapidly generate a plurality of captured images having a shutter speed different from each other.

The effect is not particularly limited to the above-described effect and may be an effect described in the present disclosure.

### BRIEF DESCRIPTION OF THE DRAWINGS

FIG. 1 is a block diagram illustrating a configuration example of an imaging apparatus according to an embodiment of the present disclosure;

FIG. 2 is a circuit diagram representing an example of a circuit configuration of an imaging sensor in the imaging apparatus illustrated in FIG. 1;

FIG. 3 is a schematic diagram when a circuit of the imaging sensor is configured with one layer;

FIG. 4 is a schematic diagram when a circuit of the imaging sensor is configured with a layered structure;

FIG. 5 is a diagram illustrating an example of an exposure timing in the imaging sensor;

FIG. 6 is a flowchart representing an example of composition processing of a captured image;

FIG. 7 is a flowchart representing an example of exposure processing and memory recording processing;

FIG. 8 is a flowchart representing an example of processing continuing from the procedure in FIG. 7;

FIG. 9 is a diagram illustrating a first example of generation processing of a captured image;

FIG. 10 is a diagram illustrating a second example of the generation processing of a captured image;

FIG. 11 is a diagram illustrating a third example of the generation processing of a captured image;

FIG. 12 is a block diagram illustrating a configuration example of an imaging apparatus according to a first modification example;

FIG. 13 is a block diagram illustrating a configuration example of an information processing apparatus and an information processing system according to a second modification example;

FIG. 14 is a diagram illustrating an example of an exposure timing in a first comparative example in which imaging is performed using a mechanical shutter; and

FIG. 15 is a diagram illustrating an example of an exposure timing in a second comparative example in which imaging is performed using an electronic focal plane shutter method instead of using the mechanical shutter.

### DETAILED DESCRIPTION OF EMBODIMENTS

Hereinafter, embodiments of the present disclosure will be described in detail with reference to the drawings. The description will be made in the following order.

1. Configuration

1.1 Example of the entire configuration of an imaging apparatus

1.2 Configuration example of a sensor section (imaging sensor)

2. Operation

2.1 Example of an exposure timing in a comparative example

2.2 Example of image composition processing

3. Effect

4. Modification example

4.1 First modification example

4.2 Second modification example (a configuration example of an information processing system)

5. Other embodiment

### 1. Configuration

### 1.1 Example of the Entire Configuration of an Imaging Apparatus

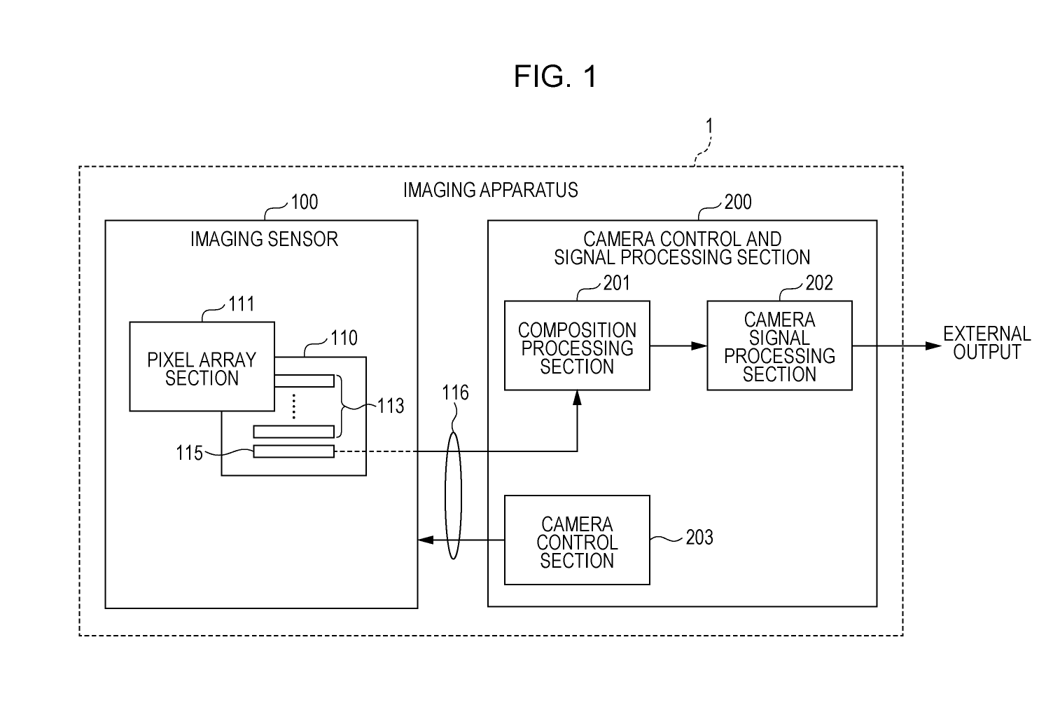

FIG. 1 is a block diagram illustrating an example of the entire configuration of an imaging apparatus 1 according to an embodiment of the present disclosure.

The imaging apparatus 1 includes an imaging sensor 100, a camera control and signal processing section 200, and an interface 116. The interface 116 is able to transmit a signal such as image data and various control signals between the camera control and signal processing section 200 and the imaging sensor 100.

The imaging sensor 100 includes a pixel array section 111 and a peripheral circuit section 110. The peripheral circuit section 110 includes an A/D conversion section (analog digital converter (ADC)) 113, and a frame memory 115. The camera control and signal processing section 200 includes a composition processing section 201, a camera signal processing section 202, and a camera control section 203.

FIG. 1 illustrates a layered structure in which the pixel array section 111 and the peripheral circuit section 110 are formed on layers different from each other. However, a structure in which the pixel array section 111 and the peripheral circuit section 110 are formed on one layer may be made. In addition, a multiple-layer structure of three or more layers in which the ADC 113 and the frame memory 115 of the peripheral circuit section 110 are formed on layers different from each other may be made. The pixel array section 111 and the peripheral circuit section 110 are electrically connected and a signal of the pixel array section 111 (signal obtained by performing photoelectric conversion of light) is transferred to the peripheral circuit section 110 as an electrical signal.

The pixel array section 111 serves as a pixel section including a plurality of pixels arranged in a matrix. The pixel array section 111 may have a Bayer array in which a color filer with one color is assigned to each pixel or may have a structure in which a color filter with a plurality of colors is assigned to each pixel.

A plurality of ADCs 113 are respectively provided for every pixel column in the pixel array section 111. A plurality of ADCs 113 are respectively provided for each area, the pixel array section 111 is divided into areas by a predefined unit, AD conversion is performed for each area, and thus it is desired to increase a capacity for performing parallel processing and to obtain an ability to perform AD conversion at a high frame rate. It is desired to obtain a capacity for performing processing on the entirety of pixels at 240 fps, for example. Eventually, the ADCs 113 may be mounted in such a manner that one ADC 113 is assigned to one pixel.

The frame memory 115 serves as a memory section in which pixel data of the entirety of pixels output from the ADCs 113 may be recorded at a high speed by a plurality of frames. The frame memory 115 capable of recording at a high speed in the imaging sensor 100 is provided and data is slowly transmitted from the imaging sensor 100 when the data is output from the imaging sensor 100 to the camera control and signal processing section 200. Accordingly, it is possible to avoid a transmission speed limit in the interface 116. Thus, the degree of freedom in transmission path design may be improved and a processing speed of performing signal processing in a large scale integrated circuit (LSI) may or may not increase up to the transmission speed limit.

As will be described later, the composition processing section 201 serves as an image processing section configured to generate a first image based on a first exposure period and a second image based on a second exposure period including the first exposure period. The imaging sensor 100 is able to output multiple items of captured image data to the composition processing section 201 through the frame memory 115, as will be described later. The multiple items of captured image data have an exposure start timing different from each other. The composition processing section 201 generates the first image and the second image based on the multiple items of captured image data which are output from the imaging sensor 100 and have the exposure start timing different from each other, as will be described later.

The camera signal processing section 202 performs general camera developing processing and outputs image data to a monitor, a recording apparatus (not illustrated), or the like. The general camera developing processing may refer to processing such as defect correction, black level adjustment, de-mosaic processing, white balance processing, gamma correction processing, and jpeg compression.

The camera control section 203 controls the entirety of the imaging apparatus 1 and performs processing of setting an imaging condition and the like based on an instruction of a user.

### 1.2 Configuration Example of the Sensor Section (Imaging Sensor)

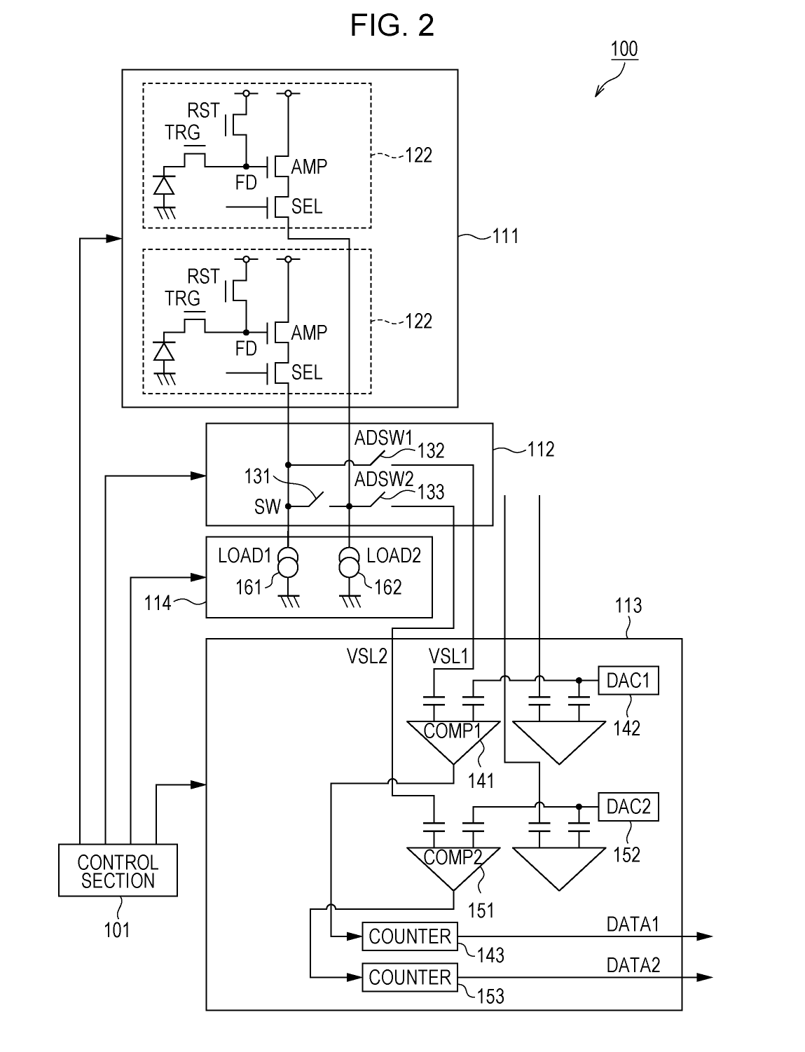

FIG. 2 represents an example of a circuit configuration of the imaging sensor 100. The imaging sensor 100 illustrated in FIG. 2 refers to a complementary metal oxide semiconductor (CMOS) imaging sensor, a charge coupled device (CCD) imaging sensor, and the like and refers to an imaging element that captures a subject and obtains digital data of the captured image.

As illustrated in FIG. 2, the imaging sensor 100 may include a control section 101, a pixel array section 111, a selection section 112, the ADC 113, and a constant current circuit section 114.

The control section 101 controls the respective sections of the imaging sensor 100 and performs processing related to reading of image data (pixel signal) and the like.

The pixel array section 111 refers to a pixel region in which pixel configurations having a photoelectric conversion element such as a photodiode are arranged in a matrix (array). The pixel array section 111 is controlled by the control section 101 such that the respective pixels receive light from a subject, and perform photoelectric conversion on the incident light to accumulate charges, and the charges accumulated in the respective pixels are output as a pixel signal at a predefined timing.

A pixel 121 and a pixel 122 are examples of two pixels vertically adjacent to each other in a pixel group disposed in the pixel array section 111. The pixel 121 and the pixel 122 are pixels at a row and a sequent row in the same column. In a case of an example in FIG. 2, as illustrated in the pixel 121 and the pixel 122, a circuit of each pixel includes a photoelectric conversion element and four transistors. The circuit of each pixel may have any configuration and may have a configuration other than the example illustrated in FIG. 2.

A general pixel array includes an output line for a pixel signal for each column. The pixel array section 111 includes two output lines (having two routes) for each column. Pixel circuits at one column are alternately connected to the two output lines in every other row. For example, a circuit of a pixel at an odd-numbered row from the top is connected to one output line and a circuit of a pixel at an even-numbered row from the top is connected to another output line. In the example of FIG. 2, a circuit of the pixel 121 is connected to a first output line (VSL1) and a circuit of the pixel 122 is connected to a second output line (VSL2).

For a convenient description, FIG. 2 illustrates only output lines for one column. However, in practice, two output lines similar to those in FIG. 2 are provided for each column. Circuits of pixels at a column are connected to the respective output lines corresponding to the column in every other row.

The selection section 112 has a switch configured to connect the respective output lines of the pixel array section 111 to an input of the ADC 113. The selection section 112 controls to connect the pixel array section 111 and the ADC 113 according to control of the control section 101. That is, a pixel signal read from the pixel array section 111 is supplied to the ADC 113 through the selection section 112.

The selection section 112 includes a switch 131, a switch 132, and a switch 133. The switch 131 (selection SW) controls to connect the two output lines mutually corresponding to the same column. For example, if the switch 131 turns ON, the first output line (VSL1) and the second output line (VSL2) are connected to each other and if the switch 131 turns OFF, the first output line (VSL1) and the second output line (VSL2) are cut off.

A detailed description will be made later, but one ADC (column ADC) is provided for each output line in the imaging sensor 100. Accordingly, if both of the switch 132 and the switch 133 turn ON and if the switch 131 turns ON, two output lines at the same column are connected to each other and thus a circuit of one pixel is connected to two ADCs. On the contrary, if the switch 131 turns OFF, the two output lines at the same column are cut off and thus the circuit of the one pixel is connected to one ADC. That is, the switch 131 selects the number of the ADC (column ADC) set to be an output destination of a signal of one pixel.

A detailed description will be made later, but the switch 131 controls the number of the ADC set to be an output destination of a pixel signal and thus the imaging sensor 100 may output more various pixel signals than before depending on the number of the ADC. That is, the imaging sensor 100 may realize to output more various data than before.

The switch 132 controls to connect the first output line (VSL1) which corresponds to the pixel 121 and the ADC which corresponds to the first output line. If the switch 132 turns ON, the first output line is connected to one input of a comparator of the corresponding ADC. If the switch 132 turns OFF, the first output line and the one input of the comparator of the corresponding ADC are cut off.

The switch 133 controls to connect the second output line (VSL2) which corresponds to the pixel 122 and the ADC which corresponds to the second output line. If the switch 133 turns ON, the second output line is connected to one input of a comparator of the corresponding ADC. If the switch 133 turns OFF, the second output line and the one input of the comparator of the corresponding ADC are cut off.

The selection section 112 switches ON and OFF of the switch 131 to the switch 133 according to control of the control section 101, and thereby may control the number of the ADC (column ADC) set to be an output destination of a signal of one pixel.

The switch 132 and the switch 133 (one or both) may be omitted and the respective output lines and the corresponding ADC are continuously connected to each other. The output line and the corresponding ADC may be controlled to be connected to each other or to be cut off by the switch 131 to the switch 133 and thus there are more selections of the number of the ADC (column ADC) which is set to be an output destination of a signal of one pixel than before. That is, the imaging sensor 100 may output more various pixel signals than before by providing the switch 131 to the switch 133.

FIG. 2 illustrates a configuration of the output lines by only one column, but in practice, the selection section 112 has a configuration (switch 131 to switch 133) similar to that illustrated in FIG. 2 for each column. That is, the selection section 112 performs connection control similar to the above description in each column according to control of the control section 101.

The ADC 113 performs A/D conversion on a pixel signal and outputs the converted signal as digital data. The pixel signal is supplied from the pixel array section 111 through the output line. The ADC 113 includes ADCs (column ADC) corresponding to each output line from the pixel array section 111. That is, the ADC 113 includes a plurality of column ADCs. A column ADC which corresponds to one output line refers to a single slope ADC which includes a comparator, a D/A converter (DAC) and a counter.

The comparator compares an output of the corresponding DAC with a signal value of a pixel signal. The counter increments a value (digital value) of the counter until the pixel signal and the output of the DAC are equal to each other. The comparator causes the counter to stop if the output of the DAC reaches the signal value. Thereafter, signals digitized by Counter 1 and Counter 2 are output to the outside of the imaging sensor 100 through DATA1 and DATA2.

The counter causes the value of the counter to return to an initial value (for example, 0) for the next AD conversion after output of data.

The ADC 113 includes column ADCs having two routes for each column. For example, a comparator 141 (COMP1), a DAC 142 (DAC1), and a counter 143 (Counter 1) are provided for the first output line (VSL1). A comparator 151 (COMP2), a DAC 152 (DAC2), and a counter 153 (Counter 2) are provided for the second output line (VSL2). Illustration is omitted, but the ADC 113 includes a similar configuration for output lines of other columns.

The DAC may be commonly used in the above-described configuration. The common use of the DAC is performed for each route. That is, the DAC of the same route in each column is commonly used. In the example of FIG. 2, a DAC corresponding to the first output line (VSL1) in each column is commonly used as the DAC 142. A DAC corresponding to the second output line (VSL2) in each column is commonly used as the DAC 152. The comparator and the counter are provided for each route of the output line.

The constant current circuit section 114 refers to a constant current circuit connected to the respective output lines. The constant current circuit section 114 is controlled by the control section 101 to drive. A circuit of the constant current circuit section 114 is configured by, for example, a metal oxide semiconductor (MOS) transistor and the like. The circuit is configured arbitrarily. However, in FIG. 2, for a convenient description, a MOS transistor 161 (LOAD1) is provided for the first output line (VSL1) and a MOS transistor 162 (LOAD2) is provided for the second output line (VSL2).

The control section 101 receives a request from the outside, for example, from a user, and selects a reading mode. The control section 101 controls the selection section 112 and controls a connection to the output line. The control section 101 may control driving of the column ADC according to the selected reading mode. The control section 101 controls driving of the constant current circuit section 114 or driving of the pixel array section 111, for example, a rate or a timing of reading, as necessary, in addition to the driving of the column ADC.

That is, the control section 101 performs control of the selection section 112 and control of sections other than the selection section 112 and thus the imaging sensor 100 may operate in more various modes than before. Accordingly, the imaging sensor 100 may output more various pixel signals than before.

The number of the respective sections illustrated in FIG. 2 may be any number as long as the number is not insufficient. For example, three or more output lines may be provided for each column and three or more ADCs may be provided for each column.

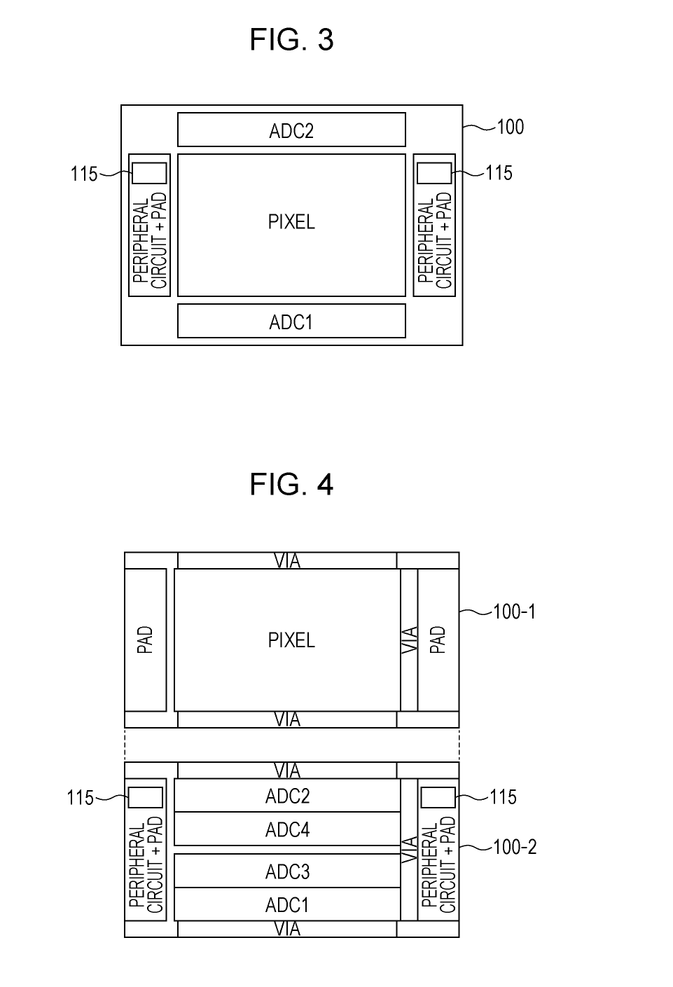

As described above, if a plurality of ADCs are provided for each column, there is a concern that the size of a chip increases and cost increases in, for example, a one-layer structure illustrated in FIG. 3. Thus, as illustrated in FIG. 4, the chip may have a layered structure.

In a case of FIG. 4, the imaging sensor 100 is configured by a plurality of chips which are a pixel chip 100-1 and a peripheral circuit chip 100-2, and PADs. The pixel array section 111 is formed in most of the pixel chip 100-1 and an output circuit, a peripheral circuit, the frame memory 115, the ADCs 113, and the like are formed in the peripheral circuit chip 100-2. Output lines of the pixel array section 111 in the pixel chip 100-1 and a drive line are connected with a circuit of the peripheral circuit chip 100-2 through a through-via (VIA).

With such a configuration, it is possible to reduce the size of a chip and to reduce cost. Since a wiring layer may have sufficient space, it is possible to easily perform wiring. The image sensor is configured by a plurality of chips, and thus it is possible to optimize the respective chips. For example, in a pixel chip, a wiring layer having a reduced height may be realized by using the wiring layer smaller than before in order to prevent degradation of quantum efficiency due to optical reflection in the wiring layer. In a peripheral circuit chip, a wiring layer may be realized by multiple layers in order to enable optimization of measures for coupling between arranged wires and the like. For example, the wiring layer in the peripheral circuit chip may be configured by more layers than the wiring layer in the pixel chip.

### 2. Operation

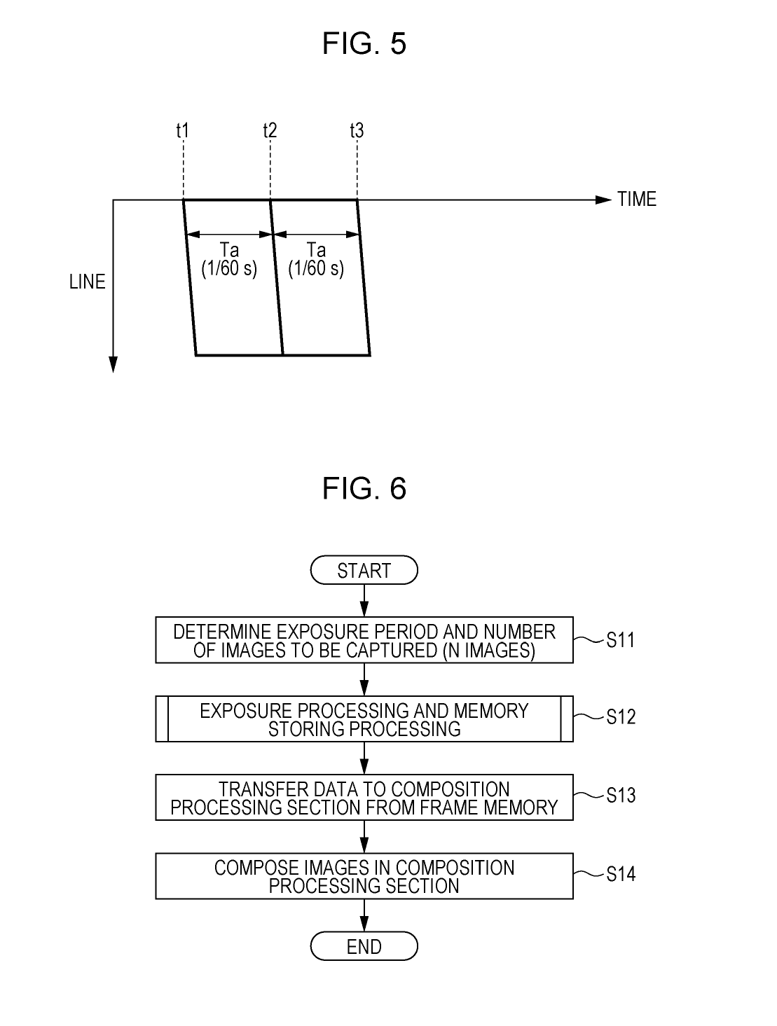

FIG. 5 is a diagram illustrating an example of an exposure timing in the imaging sensor 100 according to the embodiment. In FIG. 5, a horizontal axis indicates time and a vertical axis indicates a position of a pixel line in a vertical direction of the pixel array section 111. An example of FIG. 5 illustrates that imaging is performed sequently twice during an exposure period to (for example, 1/60 s). Imaging is performed first during a time point t1 to a time point t2 and is performed second during the time point t2 to a time point t3.

In the imaging sensor 100 according to the embodiment, a time of reading the pixel data of all pixels in the pixel array section 111 becomes short by increasing the number of the ADCs 113 to be mounted. Thus, even though a mechanical shutter as in a comparative example which will be described later is not used, it is possible to realize a high image quality with small focal plane distortion. Disuse of mechanical shutter prevents degradation of a response when mechanical driving time is done and imaging is consecutively performed. It is possible to shorten a time from ending of a shutter operation at Nth imaging to performing of a shutter operation at (N+1)th imaging.

### 2.1 Example of an Exposure Timing in a Comparative Example

An example of an exposure timing in comparative examples will be described for the exposure timing in the embodiment illustrated in FIG. 5.

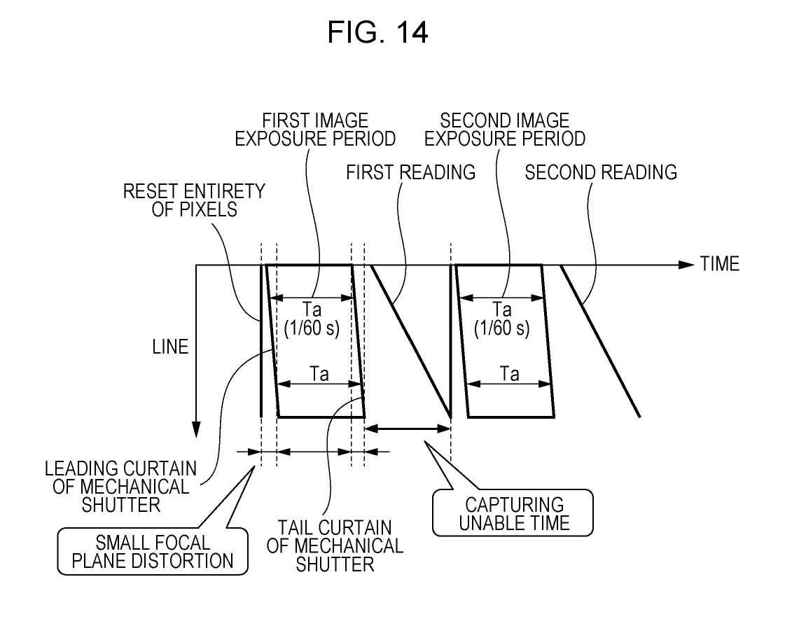

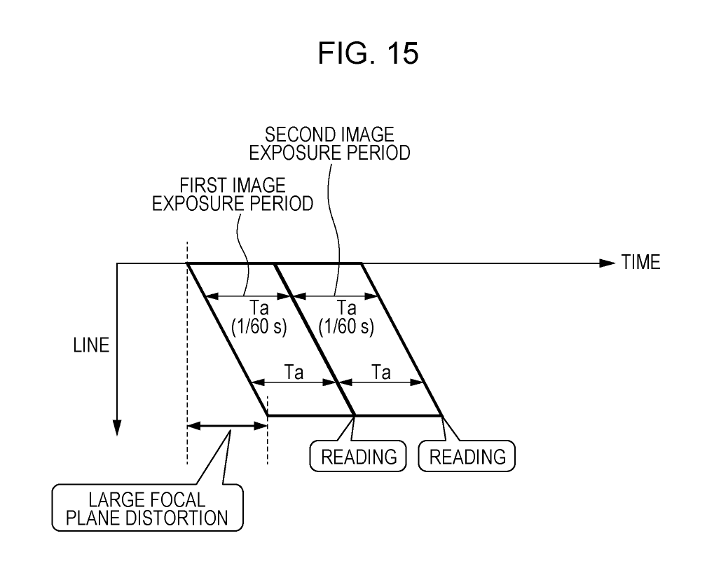

FIG. 14 illustrates an example of an exposure timing in a first comparative example in which imaging is performed using a mechanical shutter. FIG. 15 illustrates an example of an exposure timing in a second comparative example without using the mechanical shutter. In the first and second comparative examples, the pixel array section 111 is configured in such a manner that, for example, only one ADC 113 is mounted for each row. In FIG. 14 and FIG. 15, a horizontal axis indicates time and a vertical axis indicates a position of a line in a vertical direction of the pixel array section 111. FIG. 14 and FIG. 15 illustrate an example in which imaging is performed sequently twice during the exposure period to (for example, 1/60 s) in accordance with an imaging example in FIG. 5.

In the first comparative example illustrated in FIG. 14, for example, if a shutter operation is ended, time lag occurs until a next shutter operation starts when exposure is performed multiple times on all of the pixels. The number of the ADC 113 to be mounted is small, and thus reading of pixel data of all of the pixels is very slowly performed in the pixel array section 111. For this reason, focal plane distortion is avoided by slowly reading the pixel data during closing of the mechanical shutter. It is possible to make an exposure period in a vertical direction of pixels uniform by holding a time interval from a leading curtain to a tailed curtain of the mechanical shutter to be constant. It is possible to reduce focal plane distortion by increasing a speed of the mechanical shutter, for example, setting the speed to 1/240 s.

Accordingly, in the first comparative example illustrated in FIG. 14, a time for reading the pixel data is necessary in a period between an exposure period for obtaining first captured image data and an exposure period for obtaining second captured image data and thus an imaging unable time occurs. For this reason, even though the two items of captured image data are superposed to obtain a composite image with, for example, 1/30 s, a moving object in the composite image has an unnatural movement or a time period from start of imaging to end of imaging before composition is actually longer than 1/30 s.

In the second comparative example illustrated in FIG. 15, since the number of the ADC 113 to be mounted is small and the mechanical shutter is not used, a large difference between an exposure timing and reading timing of pixel data occurs in the vertical direction of the pixels. For example, exposure speed and reading speed from the top of the pixels to the bottom of the pixels are approximately 1/10 s to 1/20 s, and thereby the focal plane distortion occurs.

### 2.2 Example of Image Composition Processing

FIG. 6 represents a flow example of composition processing of a captured image in the imaging apparatus 1 according to the embodiment. First, the camera control section 203 determines an imaging condition such as an exposure period and the number of times of imaging (Step S11). The imaging condition may be automatically set by the imaging apparatus 1 or may be specified by a user. In the imaging sensor 100, the exposure processing and memory recording processing is performed under the imaging condition and, in the memory recording processing, N items of captured image data obtained by the exposure processing are recorded in the frame memory 115 (Step S12). The captured image data is transmitted from the frame memory 115 to the composition processing section 201 (Step S13). Multiple items of captured image data which are stored in the frame memory 115 and are necessary for the composition processing are transmitted to the composition processing section 201. The composition processing section 201 performs the composition processing of an image based on the multiple items of captured image data (Step S14).

In Step S12 of FIG. 6, the imaging apparatus 1 performs, in parallel, processing of, for example, recording first captured image data obtained by performing exposing during the first exposure period in the frame memory 115 and the exposure processing for obtaining second captured image data which will be described later.

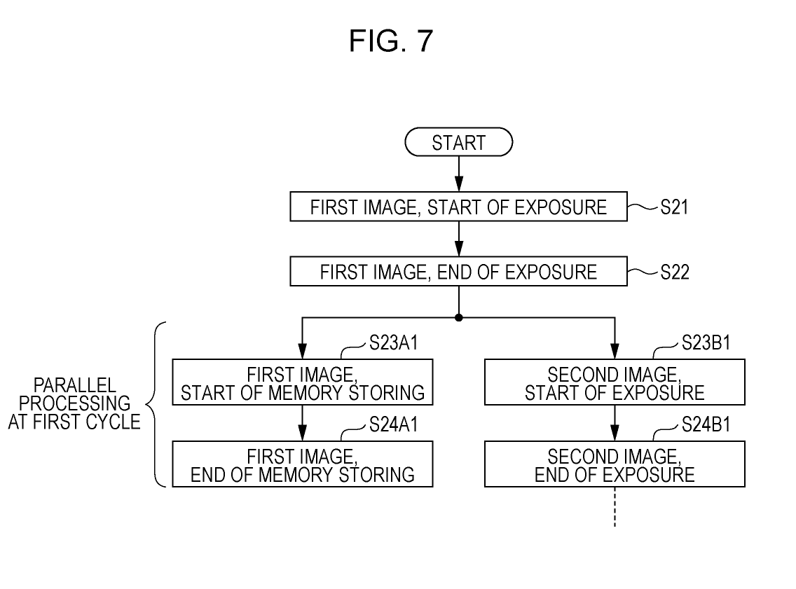

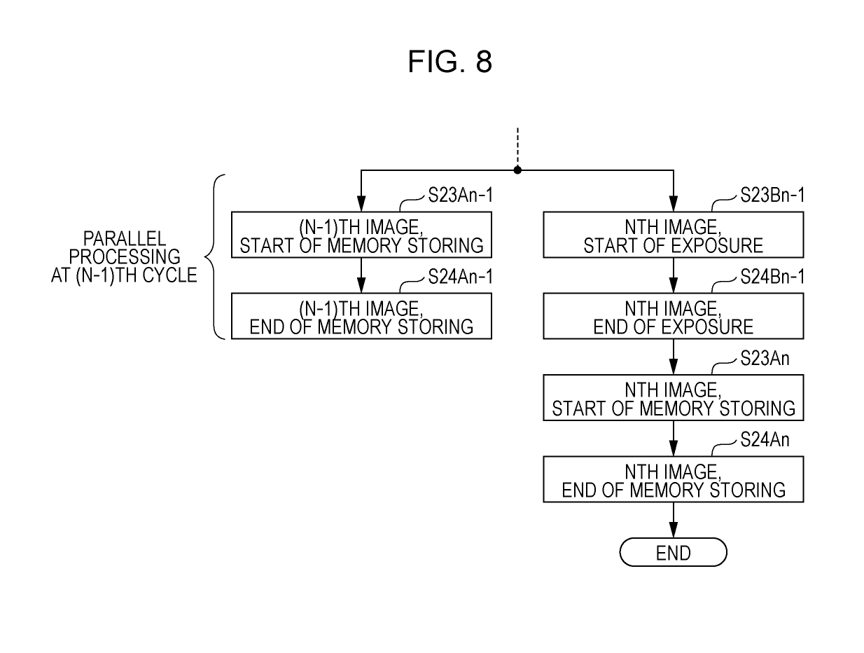

For this reason, in Step S12 of FIG. 6, for example, processing illustrated in FIG. 7 and FIG. 8 is performed. FIG. 8 represents an example of processing continuing from the procedure in FIG. 7.

First, exposure for a first captured image starts in the imaging sensor 100 (Step S21). If the exposure for the first captured image ends (Step S22), memory recording processing of the first captured image data into the frame memory 115 starts (Step S23A1) and the memory recording processing ends (Step S24A1). Exposure processing for a second captured image starts (Step S23B1) and the exposure processing ends (Step S24B1) in parallel with the memory recording processing of the first captured image data.

Then, as illustrated in FIG. 8, memory recording processing of (N−1)th captured image data into the frame memory 115 starts (Step S23An−1) and the memory recording processing ends (Step S24An−1). Exposure processing of an Nth captured image starts (Step S23Bn−1) and the exposure processing ends (Step S24Bn−1) in parallel with the memory recording processing of the (N−1)th captured image data.

If the exposure processing of the Nth captured image ends (Step S24Bn−1), memory recording processing of Nth captured image data into the frame memory 115 starts (Step S23An) and the memory recording processing ends (Step S24An). In this manner, N items of captured image data are recorded in the frame memory 115.

(Specific Example of Generation Processing of a Captured Image)

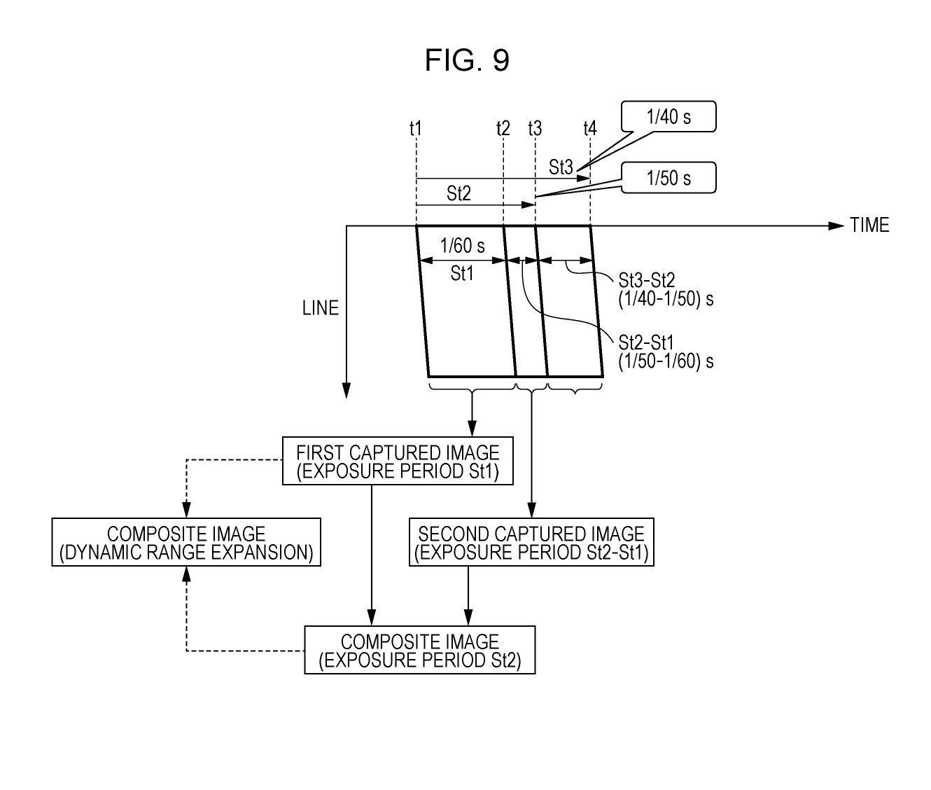

Specific examples of generation processing of a desired captured image will be described with reference to FIG. 9 to FIG. 11. In FIG. 9 to FIG. 11, a horizontal axis indicates time and a vertical axis indicates a position of a pixel line in a vertical direction of the pixel array section 111.

FIG. 9 illustrates a first example of generation processing of a captured image. In the example of FIG. 9, it is assumed that the imaging condition in Step S11 of FIG. 6 is specified by a user. For example, a desired exposure period (shutter speed) and the number of times of imaging are specified. In the imaging apparatus 1, exposure processing and image processing are performed to satisfy the imaging condition specified by the user. An upper limit of the number of times of imaging varies depending on the size of the frame memory 115.

Exposure periods for N items of desired images are specified by the user and are set to be St1 to Stn in order from the shortest exposure period. In order to generate images during each of the desired exposure periods St1 to Stn, exposure periods when imaging is performed in practice are set as follows in the imaging apparatus 1.

First exposure period when imaging is performed in practice: St1;

Second exposure period when imaging is performed in practice: St2−St1;

. . . .

Nth exposure period when imaging is performed in practice: Stn−Stn−1.

FIG. 9 illustrates an example in which three images respectively obtained during the exposure periods St1, St2, and St3 are designated as user-desired images. For example, FIG. 9 illustrates an example in which an image obtained during the exposure period St1 is set to be a first image with 1/60 s, an image obtained during the exposure period St2 is set to be a second image with 1/50 s, and an image obtained during the exposure period St3 is set to be a third image with 1/40 s.

In this case, in the imaging apparatus 1, imaging is performed during the first exposure period St1, imaging is performed during a differential period (St2−St1) between the second exposure period St2 and the first exposure period St1, and imaging is performed during a differential period (St3−St2) between the third exposure period St3 and the second exposure period St2. Accordingly, first captured image data obtained by performing imaging during the first exposure period St1, second captured image data obtained by performing imaging during the differential period (St2−St1), and third captured image data obtained by performing imaging during the differential period (St3−St2) are recorded in the frame memory 115.

The composition processing section 201 generates a first image at the desired first exposure period St1 specified by the user, based on the first captured image data obtained by performing imaging during the first exposure period St1. The composition processing section 201 generates a second image at the desired second exposure period St2 which is specified by the user by composing the first captured image data and the second captured image data.

In this manner, a plurality of images are finally obtained. In the plurality of images, at least the first exposure period St1 of the exposure periods is superimposed on other exposure periods. That is, imaging time may be partially overlapped in the embodiment, when a plurality of captured images having an exposure period different from each other are generated. Accordingly, it is possible to reduce overall imaging time.

An image having an expanded dynamic range may be generated in the composition processing section 201. It is possible to obtain a composite image having an expanded dynamic range by composing the first image at the first exposure period St1 and the second image at the second exposure period St2, for example.

The following method is performed as a composition method of captured image data in the composition processing section 201.

Method 1) Simple Composition

Add captured image data by the specified number to each other without positioning.

Method 2) Positioning

May accurately add the captured image data by calculating a motion vector and the like between the frames and matching a position and an effect with respect to the position.

Method 3) Expansion of Dynamic Range

Composition is performed without loss of a gray scale corresponding to a level as much as exceeding of a saturation level when an image obtained by adding the captured image data exceeds the saturation level after addition and thus expansion of the dynamic range is expected.

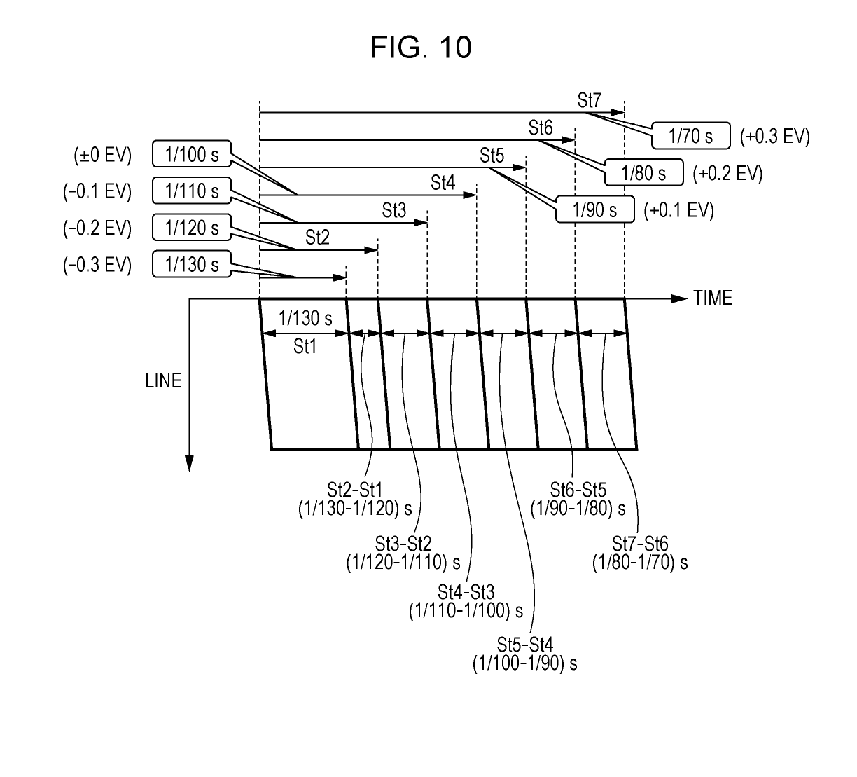

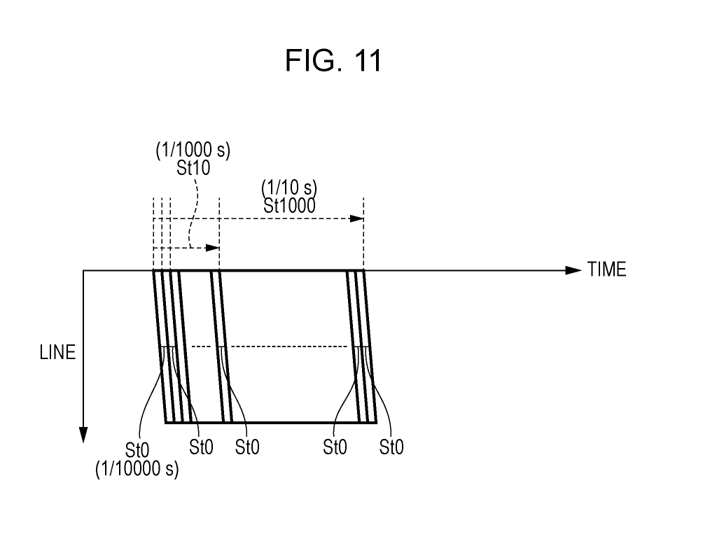

FIG. 10 illustrates a second example of the generation processing of a captured image. In the example of FIG. 10, it is assumed that the imaging condition in Step S11 of FIG. 6 is automatically set by the imaging apparatus 1. For example, a recommended shutter speed is determined in the imaging apparatus 1 by using the known method. In addition, for example, a captured image having ±0.3EV of the recommended shutter speed is finally generated. The EV value may be set to any value and may be specified by a user.

In the second example, generation processing and composition processing of an image are basically similar to those in the first example. Imaging is performed first at the fastest shutter speed and sequentially imaging is performed at a shutter speed corresponding to a differential period. Imaging is performed in order of −0.3, ±0, and +0.3. The EV value may be finely allocated when the frame memory 115 is sufficient. For example, the EV value may be allocated to −0.3, −0.2, −0.1, ±0, +0.1, +0.2, and +0.3. When composition is performed in the composition processing section 201, one or more appropriate shutter speeds may be specified in the imaging apparatus 1 (for example, values of −0.3 EV to +0.3 EV are allocated by 0.1 EV to be seven). However, the value may be selected by a user.

In the example of FIG. 10, when the recommended shutter speed is 1/100 s, if fluctuation in the EV value causes all of the shutter speeds to be changed, the EV values of −0.3, −0.2, −0.1, 0, +0.1, +0.2, and +0.3 correspond to the shutter speeds of 1/130 s, 1/120 s, 1/110 s, 1/100 s, 1/90 s, 1/80 s, and 1/70 s. Imaging is performed in order from the fastest of these shutter speeds.

In the example of FIG. 10, exposure periods when imaging is performed in practice in the imaging apparatus 1 are set as follows.

First exposure period of imaging in practice: St1= 1/130 s;

Second exposure period of imaging in practice: St2−St1=( 1/130− 1/120)s;

Third exposure period of imaging in practice: St3−St2=( 1/120− 1/110)s;

Fourth exposure period of imaging in practice: St4−St3=( 1/110− 1/100)s;

Fifth exposure period of imaging in practice: St5−St4=( 1/100− 1/90)s;

Sixth exposure period of imaging in practice: St6−St5=( 1/90− 1/80)s; and

Seventh exposure period of imaging in practice: St7−St6=( 1/80− 1/70)s.

FIG. 11 illustrates a third example of the generation processing of a captured image. The multiple items of captured image data recorded in the frame memory 115 may be image data obtained by performing exposing at a predetermined time interval St0. For example, imaging is performed rapidly multiple times at a short shutter speed and multiple items of captured image data are recorded in the frame memory 115. In the composition processing section 201, multiple items of captured image data are appropriately added to generate an image at a desired shutter speed.

FIG. 11 illustrates an example in which the predetermined time interval st0 is set to 1/10000 s and 1000 items of captured image data are recorded in the frame memory 115. Accordingly, if 10 items of captured image data are added to each other, an image equivalent to an image which is captured at a shutter speed (exposure period St10) of 1/1000 s is obtained. If 1000 items of captured image data are added to each other, an image equivalent to an image which is captured at a shutter speed (exposure period St1000) of 1/10 s is obtained.

### 3. Effect

As described above, according to the embodiment, since the first image is generated based on the first exposure period and the second image is generated based on the second exposure period including the first exposure period, it is possible to rapidly generate a plurality of captured images having a shutter speed different from each other.

The effect disclosed in the specification is only an example, the effect is not limited thereto, and other effects may be obtained. This is similarly applied to the following other embodiment and modification examples.

### 4. Modification Example

### 4.1 First Modification Example

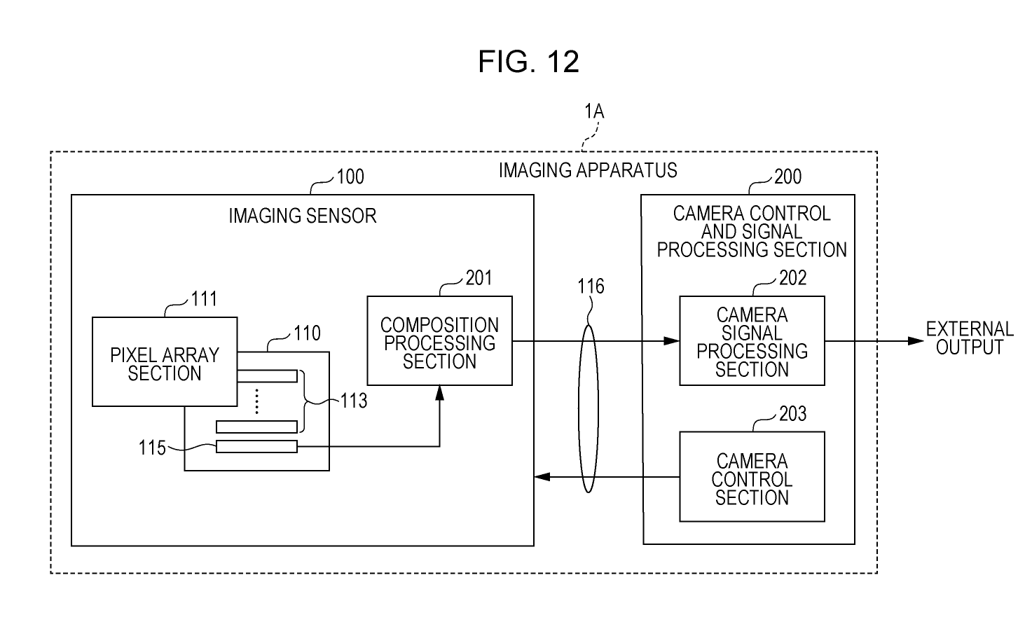

FIG. 12 illustrates a configuration example of an imaging apparatus 1A according to a first modification example. Similarly to the imaging apparatus 1A in FIG. 12, the composition processing section 201 may be provided in the imaging sensor 100.

### 4.2 Second Modification Example (Configuration Example of an Information Processing System)

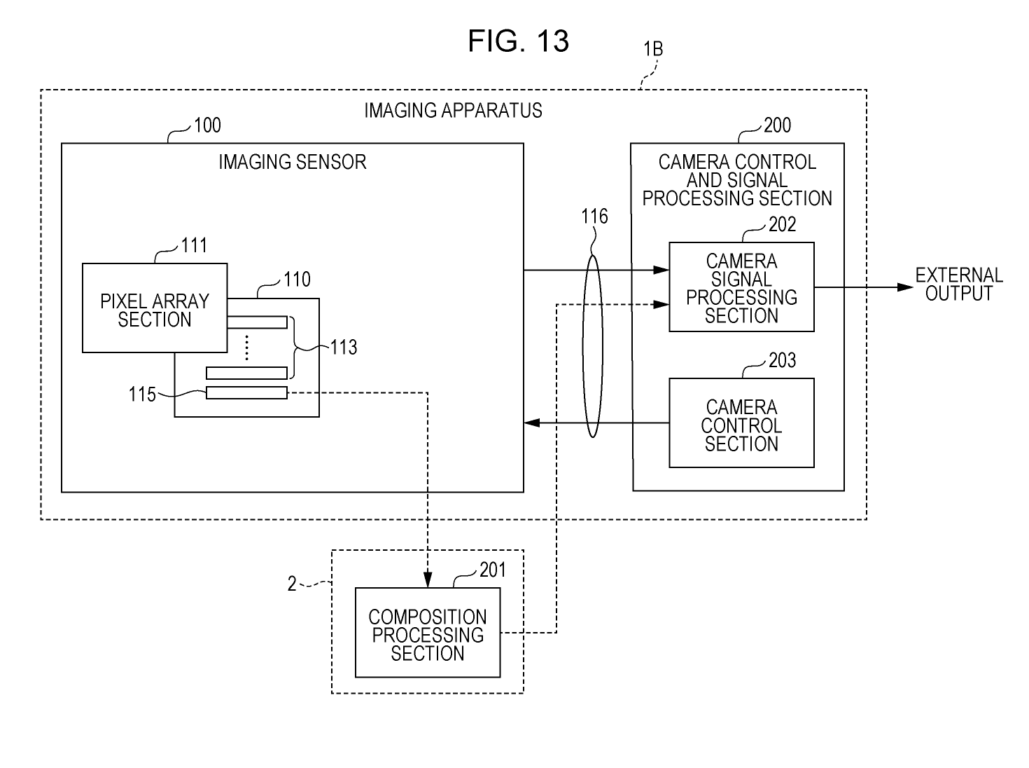

FIG. 13 illustrates a configuration example of an information processing apparatus 2 and an information processing system according to a second modification example. As illustrated in FIG. 13, the information processing system may have a configuration in which the composition processing section 201 is provided in the information processing apparatus 2 separated from an imaging apparatus 1B. The imaging apparatus 1B and the information processing apparatus 2 may be connected to each other through a wired or a wireless network. Processing of the composition processing section 201 may be performed in a so-called cloud computing manner. For example, the processing of the composition processing section 201 may be performed in a server over a network such as the Internet.

### 5. Other Embodiment

A technology according to the present disclosure is not limited to the description of the above-described embodiment and various modification embodiments may be made.

For example, the technology may have the following configurations.

(1) An information processing apparatus includes an image processing section configured to generate a first image based on a first exposure period and a second image based on a second exposure period including the first exposure period.

(2) In the information processing apparatus according to (1), the image processing section generates the first image and the second image based on multiple items of captured image data having an exposure start timing different from each other.

(3) In the information processing apparatus according to (1) or (2), the image processing section generates the first image based on first captured image data obtained by performing imaging during the first exposure period and generates the second image by composing the first captured image data and at least one item of second captured image data, the second captured image data being obtained by performing imaging during a differential period between the second exposure period and the first exposure period.

(4) In the information processing apparatus according to any one of (1) to (3), the image processing section further generates a third image by composing the first image and the second image.

(5) The information processing apparatus according to (2) or (3) further includes a memory section that enables the multiple items of captured image data to be recorded therein.

(6) In the information processing apparatus according to (2), the multiple items of captured image data are obtained by performing exposure at a predetermined time interval.

(7) In the information processing apparatus according to (2), the multiple items of captured image data are obtained by performing exposure at a time interval which is obtained based on the first exposure period and a differential period between the second exposure period and the first exposure period.

(8) An information processing method causing an image processing section to generate a first image based on a first exposure period and a second image based on a second exposure period including the first exposure period.

(9) An information processing system includes an image processing section configured to generate a first image based on a first exposure period and a second image based on a second exposure period including the first exposure period.

(10) The information processing system according to (9) further includes an imaging apparatus configured to output multiple items of captured image data having an exposure start timing different from each other, in which the image processing section generates the first image and the second image based on the multiple items of captured image data output from the imaging apparatus.

(11) An imaging apparatus includes an image processing section configured to generate a first image based on a first exposure period and a second image based on a second exposure period including the first exposure period.

(12) The imaging apparatus according to (11) further includes a sensor section configured to output multiple items of captured image data having an exposure start timing different from each other, in which the image processing section generates the first image and the second image based on the multiple items of captured image data output from the sensor section.

(13) In the imaging apparatus according to (12), the sensor section includes a pixel section having a plurality of pixels arranged in a matrix and a plurality of A/D conversion sections provided corresponding to each pixel column in the pixel section.

(14) In the imaging apparatus according to (13), the sensor section further includes a memory section configured to record pixel data output from the A/D conversion section by a plurality of frames.

(15) In the imaging apparatus according to (14), processing of recording first captured image data in the memory section and exposure processing are performed in parallel, the first captured image data being obtained by performing exposure during the first exposure period in the sensor section and the exposure processing being for obtaining second captured image data during a differential period between the second exposure period and the first exposure period in the sensor section.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing apparatus comprising:
an image processing section configured to generate a first image based on a first exposure period and a second image based on a second exposure period including the first exposure period.

2. The information processing apparatus according to claim 1, wherein
the image processing section generates the first image and the second image based on multiple items of captured image data having an exposure start timing different from each other.

3. The information processing apparatus according to claim 1, wherein
the image processing section generates the first image based on first captured image data obtained by performing imaging during the first exposure period and generates the second image by composing the first captured image data and at least one item of second captured image data, the second captured image data being obtained by performing imaging during a differential period between the second exposure period and the first exposure period.

4. The information processing apparatus according to claim 1, wherein
the image processing section further generates a third image by composing the first image and the second image.

5. The information processing apparatus according to claim 2, further comprising:
a memory section that enables the multiple items of captured image data to be recorded therein.

6. The information processing apparatus according to claim 2, wherein
the multiple items of captured image data are obtained by performing exposure at a predetermined time interval.

7. The information processing apparatus according to claim 2, wherein
the multiple items of captured image data are obtained by performing exposure at a time interval which is obtained based on the first exposure period and a differential period between the second exposure period and the first exposure period.

8. An information processing method comprising:
causing an image processing section to generate a first image based on a first exposure period and a second image based on a second exposure period including the first exposure period.

9. An information processing system comprising:
an image processing section configured to generate a first image based on a first exposure period and a second image based on a second exposure period including the first exposure period.

10. The information processing system according to claim 9, further comprising:
an imaging apparatus configured to output multiple items of captured image data having an exposure start timing different from each other,
wherein the image processing section generates the first image and the second image based on the multiple items of captured image data output from the imaging apparatus.

11. An imaging apparatus comprising:
an image processing section configured to generate a first image based on a first exposure period and a second image based on a second exposure period including the first exposure period.

12. The imaging apparatus according to claim 11, further comprising:
a sensor section configured to output multiple items of captured image data having an exposure start timing different from each other,
wherein the image processing section generates the first image and the second image based on the multiple items of captured image data output from the sensor section.

13. The imaging apparatus according to claim 12, wherein
the sensor section includes a pixel section having a plurality of pixels arranged in a matrix and a plurality of A/D conversion sections provided corresponding to each pixel column in the pixel section.

14. The imaging apparatus according to claim 13, wherein
the sensor section further includes a memory section configured to record pixel data output from the A/D conversion section by a plurality of frames.

15. The imaging apparatus according to claim 14, wherein
processing of recording first captured image data in the memory section and exposure processing are performed in parallel, the first captured image data being obtained by performing exposure during the first exposure period in the sensor section and the exposure processing being for obtaining second captured image data during a differential period between the second exposure period and the first exposure period in the sensor section.
